(19) United States
(12) Patent Application Publication
(10) Pub. No.: US 2007/0185745 A1
(43) Pub. Date: Aug. 9, 2007

(54) RESERVATION AND TICKETING PROCESS FOR SPACE-AVAILABLE SEATS TO AIRLINE EMPLOYEES

(75) Inventor: Tristan Schukraft, West Hills, CA (US)

Correspondence Address: KELLY LOWRY & KELLEY, LLP, 6320 CANOGA AVENUE, SUITE 1650, WOODLAND HILLS, CA, 91367, US

(73) Assignee: NON-REVENUE HOLDINGS, LLC, West Hills, CA (US)

(21) Appl. No.: 11/672,426

(22) Filed: Feb. 7, 2007

Related U.S. Application Data
(60) Provisional application No. 60/766,709, filed on Feb. 7, 2006.

(51) Int. Cl. G06Q 10/00

(52) U.S. Cl. 705/5

(57) ABSTRACT

A process for reserving and ticketing interline travel for an airline employee affiliate. The airline employee affiliate develops a travel itinerary for interline travel. The travel itinerary is processed in electronic form in a common information platform administered by a third party purchase facilitator. An electronic ticket data is associated with the travel itinerary in the common information platform, wherein the electronic ticket data is in an electronic format compatible with a transporting airline reservation system. Finally, the electronic ticket data and travel itinerary are transmitted to a carrier reservation system for listing the airline employee affiliate for travel on the transporting airline.

### BACKGROUND OF THE INVENTION

The present invention relates to airline reservation and ticketing processes. More particularly, the present invention relates to reservation and ticketing of space-available and positive-space seating to airline employees.

Since the first days of commercial airline flight, airline carriers have been burdened with the job of making reservations and writing or printing out passenger tickets on paper. In recent years, the reservation and ticketing process for commercial airline passengers developed electronically. A prospective airline passenger desiring to book a seat on an aircraft may go through either a travel agent or the airline carrier. The travel agent or airline carrier searches an electronic reservation and ticketing system administered by the transporting airline to ascertain seat availability and costs for the desired date, time, and flight destination. Once informed that a seat is available for the desired date, time, and destination, the prospective airline passenger then selects a seat and pays for the fare. The travel agent or airline carrier then issues either a paper ticket or an electronic ticket. To obtain a boarding pass, the paper ticket or electronic PNR/record locator is provided to an airline agent at the departure gate. If the airline passenger does not check-in for the flight (e.g., a no-show), the seat assigned to that airline passenger becomes available for use by standby passengers. Standby passengers are prospective airline passengers who pay for a standby ticket and wait at the airline gate for a seat on a less than fully booked flight or for a seat that opens up on a fully booked flight because other passengers fail to check-in.

Computerized reservation and ticketing systems for transportation services generally have real-time information concerning capacity, routes served, schedules for those routes, and pricing information. These systems perform a variety of functions including managing capacity, quoting prices to potential service users, administering retail passenger reservations requests, collecting payments, tracking service delivery, and reconciling any issues after the service is delivered.

The reservation and ticketing system briefly described above is only one example of a computerized retail reservation system. Retail reservation systems range from simple web-based applications to large complex mainframe computer systems like SABRE. The airlines use large complex mainframe systems to integrate and consolidate all the operations of passenger travel into one system. Hence, all major airlines can provide consolidated airline travel through these computerized reservation and ticketing systems. The main goal of an airline reservation and ticketing system is to generate optimum revenue from a fixed set of routes, by maximizing the number of passengers traveling per flight between destinations. Even with the use of such an advanced reservation and ticketing system, airline seats are still available despite the availability of standby passengers ready to fly.

Nonrev generally refers to passengers on commercial airline flights that do not produce revenue for the transporting airline during travel. The term “nonrev” is an abbreviation used by airlines to designate “non-revenue”. Most nonrev airline passengers are employees of the transporting airline. Airline employees, including airline employee family members, travel agents, affiliate company employees, and anyone eligible to receive airline transportation benefits are herein collectively referred to as “airline employee affiliates”. Airline employee affiliates also fall into the category of nonrev passengers. Airline employee affiliates also typically receive free or reduced rate travel as an employment benefit through direct employment with a transporting airline or as an indirect benefit via a relationship with someone who is employed by a transporting airline. Airline travel benefits are a valuable part of an employee compensation package. Interline travel allows airline employee affiliates to travel at a fraction of the cost relative to non-travel industry related airline passengers. Interline travel also includes travel by airline employee affiliates on a transporting airline other than the affiliated employing airline.

There are currently four predominant methods of calculating interline travel fare costs for airline employee affiliates: (1) Zonal Employee Discount (ZED); (2) Interline Discount (ID); (3) Service Fares (SVC); and (4) flat fares. ZED was formed in 1994 to simplify travel arrangements and costs for airline employees traveling on airline carriers other than the employing airline. ZED is an association of over 140 participating airlines. Most, but not all, interline travel agreements are reciprocal agreements between the transporting airline and employing airline. These contracts are often called “bilateral agreements”. Airline agreements may also vary with respect to embargos and restrictions on code shares.

Prior to ZED, airlines primarily calculated interline travel fares based on the ID System (e.g., ID90, ID50, etc.). ID ticket prices are based on a percentage discount off the published full fare price corresponding to the same origin and destination. For example, the ID90 fare discount is 90% off the most expensive economy fare (also called a “YY” fare). The airline employee pays 10% of the published YY fare. All participating airlines are subject to the same ID90 rules. A similar set of rules applies to the other ID systems (ID75, ID50, etc.) Under the ID50 system, an airline employee can usually place a firm airline seat reservation, but will be the first bumped from the flight in the event of overbooking.

ZED created travel zones with specific fare prices to better facilitate the predictability of fares and to ease interline travel planning and ticketing. ZED uses mileage to determine the fare for non-revenue, space-available travel. ZED does not use a percentage of a published fare, like the ID System. ZED currently breaks interline travel into nine zones within the range of 1-9,000 miles (i.e., Zone 1=1 to 450 miles, Zone 2=451 to 750 miles, Zone 3=751 to 1,600 miles, Zone 4=1,601 to 3,200 miles, Zone 5=3,201 to 4,080 miles, Zone 6=4,081 to 5,000 miles, Zone 7=5,001 to 6,100 miles, Zone 8=6,101 to 7,100 miles, and Zone 9=7,101 to 9,000 miles). ZED also includes three fare levels within the nine mileage zones: ZED High (ZH), ZED Medium (ZM), and ZED Low (ZL). Bilateral agreements for interline travel within the ZED framework may vary. One such variation includes calculating interline travel fares based on the three fare levels described above. The bilateral agreements in ZED may also impose reciprocal restrictions on employee affiliates, routes, and ticket quantities. The ZED system is extensive and does not depend only on airline alliances. Different airlines from different airline alliances may join ZED.

In other agreements, airlines sell “over the counter” standby tickets to employees of other airline carriers. These airlines can charge a predetermined, nominal SVC for transportation or calculate airfare under ZED, ID, or other fare rules. In yet other agreements, transporting airlines charge airline employee affiliates a flat fare for interline travel. For flat fares, the interline ticket cost does not fluctuate. Regardless of the city of origin, destination, distance, or date and time of the flight, the cost is constant.

To fly interline, some transporting airlines only require an airline employee ID card before allowing the airline employee affiliate to purchase interline travel. But, other transporting airline may require a request letter from the employing airline. Such a request for interline travel may or may not be granted by the transporting airline. Individual interline travel requests are particularly cumbersome when there is no previous agreement between the employing airline and the transporting airline.

Interline travel for airline employee affiliates is further complicated because the reservation and ticketing systems of individual airlines are unable to communicate with one another. Airline employee affiliates are unable to go back to a common kiosk or reservation system to change itineraries due to overbooking, missed flights, etc. The airline employee affiliate must deal with both the employing airline and transporting airline to obtain ticket refunds for flights not flown. Furthermore, portability of interline tickets is hindered as airline carriers tend to have multiple interline travel agreements. The terms of each agreement depends on a number of factors including the airline. For example, an airline employee purchases an interline ticket under the ZED fare rules. If the airline employee then decides that travel with that particular ticket is not possible, the interline ticket can is not necessarily transferable to a different transporting airline. In some cases traditional paper tickets are transferable, but all e-tickets are not. Portability depends on the bilateral agreement between the transporting airline and the employing airline. If the employing airline has an agreement with the new transporting airline specifying ID90 fare rules, the airline employee must purchase a second ticket and seek a refund for the first ticket.

Additionally, arranging interline travel is a cumbersome process for airline employee affiliates endeavoring to travel on transporting airlines other than the employing airline. Currently, there is little or no coordination between the computer reservation and ticketing systems of the various airline carriers. Further, some airline carriers do not maintain electronic reservation and scheduling systems. Buying and maintaining such a system can be cost prohibitive, especially for a small airline carrier with limited funds.

The International Air Transport Association (IATA) mandates that all airline ticketing must be by e-ticket by Jan. 1, 2008. As a result, transporting airlines must develop individual direct e-ticketing connections among affiliated airlines, connect to an interline e-ticketing “HUB” such as the process of the present invention, or prepared to revoke the interline travel benefits from the airline employee affiliates. To build a direct connection for each interline agreement, the airlines will be required to modify existing reservation and ticketing systems to be compatible with other airline reservation and ticketing systems. Compatibility among multiple transporting airlines is cost prohibitive. There are enormous administrative and cost implementation issues, which include issuing tickets on behalf of the interline employee, employment verification for airline employee affiliates, and little or no flexibility for last minute changes to an interline travel itinerary. Furthermore, the transporting airline absorbs merchant fees and other e-ticketing costs. These fees will tend to be higher for larger airlines that issue far more interline tickets than smaller airlines. Transporting airlines must administer interline travel ticket refund requests, the employing airline must administer certain interline travel ticket refund disputes, and airline employee affiliates will experience limited payment options and must deal with multiple refund policies. Ultimately airlines without electronic reservation systems cannot participate.

In one example, if the transporting airline were to provide e-ticket fulfillment, the transporting airline would absorb the cost of merchant fees and other related fees. Large airlines like Delta, British Airways, or Cathay Pacific would spend millions annually. Specifically, a ZED Medium fare from LAX to JMB costs $10.81 USD in merchant fees alone. To further complicate matters, airline employee affiliates often request backup itineraries that are not used. The transporting airline absorbs the costs associated with these backup itineraries as well. Without interchangeability of an interline e-ticket connection through a common database or system, airline employees are forced to buy these backup itineraries and then go through the process of requesting multiple refunds when those backup itineraries go unused.

Accordingly, there is a need for a process that interconnects airline carrier computer reservation and ticketing systems in a format that is user friendly for interline travelers. There is a further need for a process that interconnects airline carrier computer reservation and ticketing systems to facilitate cost effective e-ticketing and interline travel. The present invention fulfills these needs and provides other related advantages.

### SUMMARY OF THE INVENTION

The present invention is for a process for reserving and ticketing space-available and positive-space available seats to an airline employee affiliate. The eligibility of the airline employee affiliate to fly interline travel is verified by retrieving employment information from an employer database. The airline employee affiliate can access the common information platform and interline fare calculator after verification through a web-based program, an intranet, or a kiosk. The airline employee affiliate develops an interline travel itinerary for travel on a transporting airline. This includes searching fares of at least one transporting airline reservation system using the interline fare calculator accessible through the common information platform. Furthermore, the airline employee affiliate can calculate a total travel expense including fares, taxes, fees, and service charges.

Once the interline travel itinerary is developed, the itinerary is then processed in electronic form in the common information platform administered by the third party purchase facilitator. In one embodiment of the present invention, electronic ticket data is generated by the common information platform based on the interline travel itinerary chosen by the airline employee affiliate. Electronic ticket data includes any electronic ticket, e-ticket, paper ticket, paperless ticket, ticketless travel, or other travel authorization or ticketing.

In another embodiment, the electronic ticket data is generated by the transporting airline reservation system based on the interline travel itinerary transmitted to the transporting airline reservation system by the common information platform. In still yet another embodiment of the present invention, the processing of the interline travel itinerary includes formatting the interline travel itinerary in the common information platform for compatibility with an employing airline reservation system. The interline travel itinerary is then transferred in electronic form for automatic reception by the employing airline reservation system, wherein the employing airline reservation system creates the electronic ticket data based on the interline travel itinerary transferred by the common information platform. The common information platform then receives the electronic ticket data from the employing airline reservation system.

The common information platform then associates the electronic ticket data with the interline travel itinerary, wherein the electronic ticket data and the interline travel itinerary are stored in a format for automatic reception by a transporting airline reservation system. The interline travel itinerary is then transmitted to the transporting airline reservation system for listing the airline employee affiliate for travel on the transporting airline.

In another embodiment of the present invention, the interline travel itinerary and electronic ticket data can be modified by canceling the electronic ticket data with the transporting airline reservation system through the common information platform. Interline travel itineraries, travel history, and airline employee affiliate travel statistics can also be stored in the common information platform. This information is also associated with an airline employee affiliate profile that is accessible by both the airline employee affiliate and the employing airline. Airline employee affiliates also may add or subtract a dependent, subsidiary, or affiliate from the interline travel itinerary. The common information platform automatically updates any interline travel itinerary changes or electronic ticket data changes with the transporting airline reservation system. Furthermore, the common information platform can list the airline employee affiliate for standby travel on the transporting airline. The boarding priority of the airline employee affiliate is based off the employment information stored in the common information platform.

In another embodiment of the present invention, the airline employee affiliate is notified of an embargo or flight restriction via an electronic message, wherein that message originates from the common information platform. Additionally, the common information platform can facilitate the negotiation of bilateral interline travel agreements, wherein the employing airline electronically conveys the contract offer to a transporting airline through the common information platform.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings.

FIG. 1 is a flowchart that illustrates the overall reservation and ticket process of the present invention;

FIG. 2 is a flowchart that illustrates a listing process of the present invention;

FIG. 3 is a flowchart that illustrates a process for travel fulfillment by a third party purchase facilitator;

FIG. 4 is a flowchart that illustrates a process for travel fulfillment by an employing airline;

FIG. 5 is a flowchart that illustrates a process for travel fulfillment by the transporting airline;

FIG. 6 is an alternative illustration of the flowchart of FIG. 4;

FIG. 7 is an alternative illustration of the flowchart of FIG. 5, illustrating manual paperless e-ticketing by the transporting airline;

FIG. 8 is an alternative illustration of the flowchart of FIG. 5, illustrating automated paperless e-ticketing by the transporting airline; and

FIG. 9 is a flowchart illustrating the process and communication of the interline fare calculator.

### DETAILED DESCRIPTION OF THE PREFERRED EMBODIMENTS

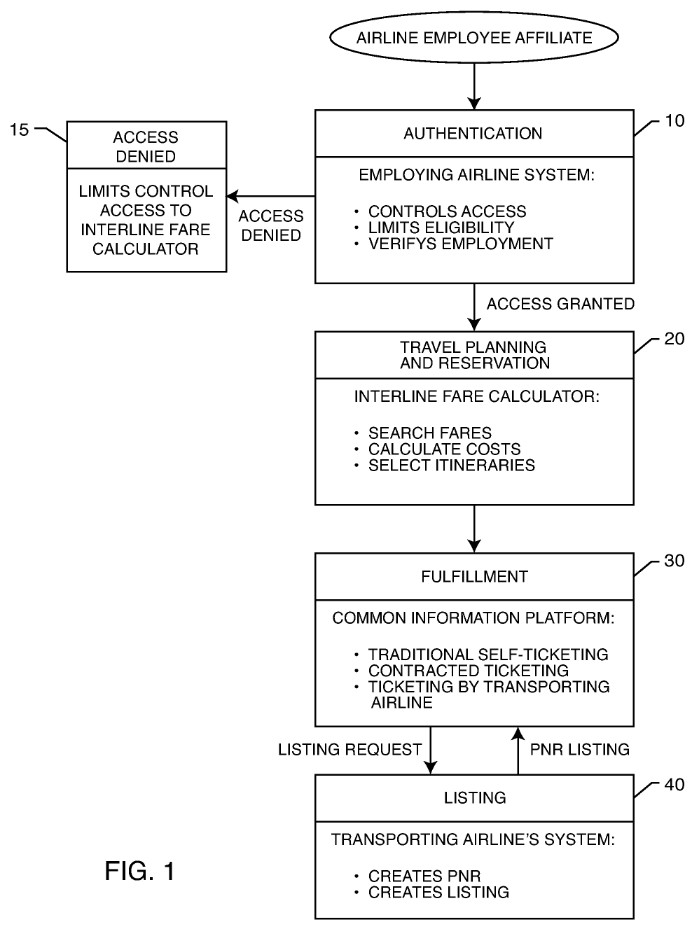

As shown in FIGS. 1-9 for purposes of illustration, the present invention discloses a process for reserving and ticketing positive-space or space-available seating for airline employee affiliates. In accordance with an embodiment of the present invention, a company acts as a third party “purchase facilitator” to collect funds, issue e-tickets, and manage travel reservations for interline travel by airline employee affiliates. The third party purchase facilitator or other service providers provide an unbiased web-based platform which interconnects multiple airline computer reservation systems, GDS's, or other service providers in a secure environment. The third party purchase facilitator will also provide web-based access to employees of airlines that do not offer electronic ticketing. In turn, airline employers can provide a cost effective electronic interline travel reservation system that protects the airline travel privileges of airline employee affiliates. The third party purchase facilitator charges the airline employee affiliate or employing airline a nominal transaction fee to cover maintenance costs, system improvements, credit card transaction costs, and other related fees.

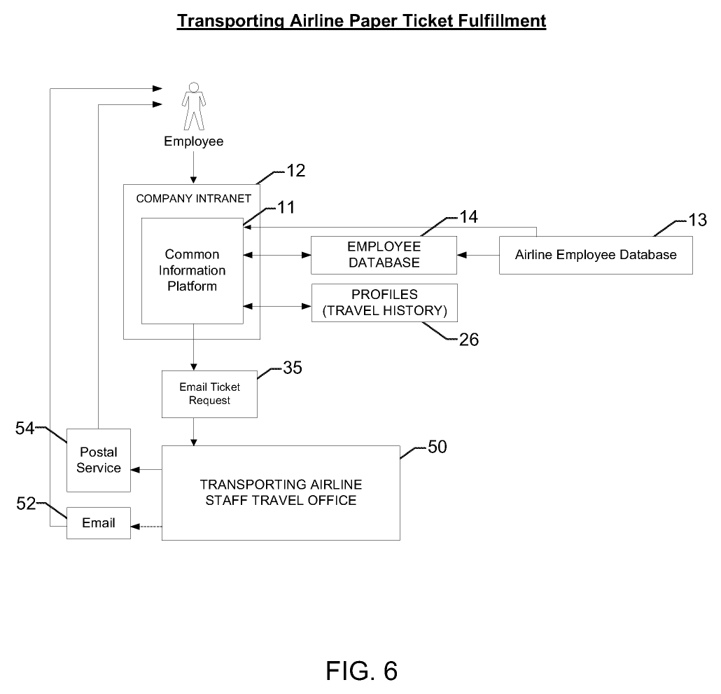

FIG. 1 is a representative flowchart that illustrates the overall reservation and ticketing process of the present invention. The first step in the process for reserving and ticketing positive space and/or space-available seating for airline employee affiliates is an authentication stage 10. The airline employee affiliate must first log into a third party purchase facilitator web-based common information platform 11 (FIGS. 6-8). Access to the common information platform 11 is provided electronically through the Internet, an employing airline intranet 12 (FIGS. 6-8), a kiosk, cell phone, personal digital assistant (PDA), or other electronic device known in the art that provides access to an electronic database. Access through a secure web site is particularly conducive for airline employee affiliates of employing airlines that do not have an established intranet or electronic reservation system. The third party purchase facilitator controls employee access, limits eligibility, and verifies employment during the authentication stage 10. The third party purchase facilitator requires employment verification of the airline employee affiliate before granting access to the common information platform 11. It is preferred that employment is verified by accessing a Lightweight Directory Access Protocol (LDAP), a ZED card, an intranet authentication protocol, or other non-intrusive validation protocols directly linked to the airline employee database 13 (FIGS. 6-8). But, other web-based validation methods known in the art may also be used. An employee database 14 (FIGS. 6-8) hosted by a third party or the common information platform 11 is also conceived in the present invention.

An eligibility authenticator limits control access to the common information platform 11 during the authentication stage 10. The eligibility authenticator communicates information in an encrypted form along a Secure Socket Layer (SSL). SSL works by using a private key to encrypt data that is transferred over the SSL connection. Encrypted words and script inhibitors prevent unauthorized access to the common information platform 11.

The authentication stage 10 validates the airline employee affiliate to ensure that the user logging into the common information platform 11 is an airline employee affiliate. The eligibility authenticator asks the airline employee affiliate a series of questions to determine employment status and interline travel eligibility. Information required during the validation process may include, username, password, name, employee number, Social Security number, date of birth, or date of hire. The answers inputted by the airline employee affiliate are transferred to the airline employee database 13 through the Human Resources (HR) department or the employee database 14 via either the LDAP or an XML transfer protocol. LDAP has access to directories that retain information such as employee records, customer preferences, patient information, student records, and public records. LDAP is a protocol that enables interoperation of multiple databases. The present invention contemplates compatibility with both LDAP and XML depending on which protocol the employing airline uses. The transfer protocol system (i.e., LDAP or XML) only exchanges information between the common information platform 11 and the information stored on another database, such as the airline employee database 13 of the employing airline HR department.

After the information inputted by the airline employee affiliate is cross-referenced using the LDAP or XML protocol, the eligibility authenticator returns either a value of “TRUE”, if the information provided by the airline employee affiliate is correct, or returns a value of “FALSE”, if any portion of the information provided by the airline employee affiliate is incorrect. The airline employee affiliate is denied access to the common information platform 11 when the eligibility authenticator returns a value of “FALSE”. The airline employee affiliate is moved to a denied access stage 15 that limits control access to the common information platform 11. Absent authentication, the airline employee affiliate is unable to use the interline fare calculator to research interline travel flight benefits. Additionally, steps concerning travel, reservation, and ticketing are unavailable.

Airline employee affiliates may also access the interline fare calculator in the common information platform 11 as a stand-alone research tool. In this embodiment, the airline employee affiliate uses a generic username and password issued by the employing airline for use with all its airline employee affiliates. Airline employee affiliates are able to create an interline travel itinerary, but ultimately need to request approval from the employing airline, since the airline employee affiliate is not personally identified upon login to the common information platform 11. E-ticket issuance is also administered by the employing airline. But, this process is not as efficient and cost effective for the employing airline as individual airline employee affiliate account profiles stored in the common information platform 11. In this embodiment, the common information platform 11 would not validate the airline employee affiliate via LDAP or XML.

By utilizing LDAP or XML, airlines are able to accurately validate employee employment and eligibility online and in real-time. As a result, there is no need for an employing airline issued reader card and corresponding middle-ware solution, which only adds costs associated with administrative time. Although, it is conceived that such a reader card and middle-ware solution could be integrated with the present invention. Information transferred to the third party purchase facilitator during the authentication stage 10 may or may not be retained in the common information platform 11.

In an alternative embodiment of the present invention, the common information platform 11 can directly connect, in a secure environment, to the airline employee database 13 of the employing airline HR department. The airline employee affiliate similarly responds to a number of validation questions. The inputted answers are verified by connecting directly to and accessing information stored in the airline employee database 13. Input information might include the names of eligible travelers and relationships, e-mail addresses, an employment or employee number, date of employment, credit card information, addresses, or contact numbers. The common information platform 11 communicates with the airline employee database 13 to verify the accuracy of the answers. Before granting access to the common information platform 11, the eligibility authenticator requires a “TRUE” response. Interline eligibility and other required information is processed at this point. The airline employee affiliate is then able to proceed to a travel planning and reservation stage 20.

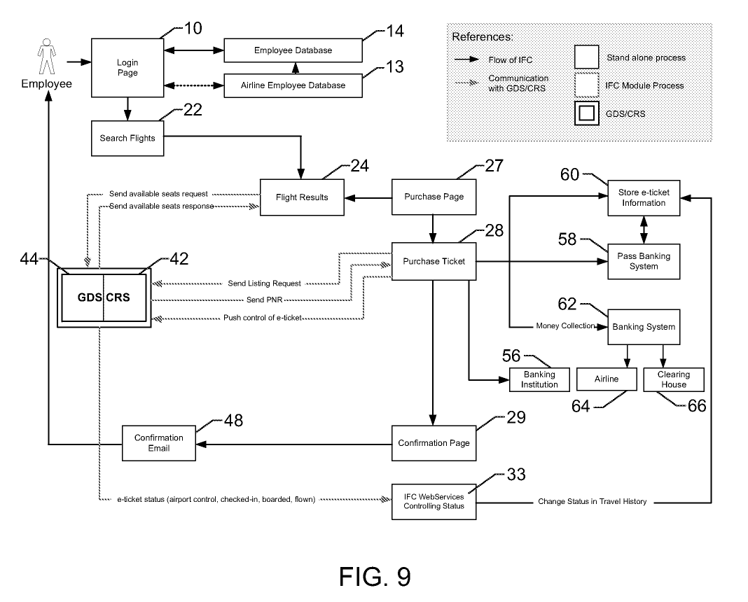

Access to the common information platform 11 travel and reservation planning is granted when the third party purchase facilitator verifies the correct responses via the eligibility authenticator. Once access is granted, the airline employee affiliate enters the travel planning and reservation stage 20. Here, the airline employee affiliate has access to an interline fare calculator, such as the ZED Fare Calculator™, for searching fares, calculating costs, and storing itineraries. The airline employee affiliate searches for fares during a flight search stage 22 (FIG. 9) based on eligibility and flight schedules published by the employing airline and other transporting airlines via public resource. Fare searches may include a number of different criteria including, but not limited to, flight costs, date, availability, origin, and destination. It is further conceived in the present invention that all information associated with flight travel could be searched. A search result stage 24 (FIG. 9) is also sortable according to the above-mentioned criteria.

The interline fare calculator also calculates the entire interline travel cost. This calculation includes taxes, charges, and fees—including airport fees, security fees, and governmental fees applicable to interline travel—in addition to the interline travel fare. Taxes are calculated based on information provided by IATA. To calculate the total cost of the travel itinerary, the interline fare calculator verifies the tax rules, type of flight, passenger categories, class of service and if the passenger is transiting. Since all this information is compiled within the database of the common information platform 11, the interline fare calculator is capable of providing a fast and accurate interline travel itinerary cost.

More specifically, the interline fare calculator is the end user interface for airline employee affiliates to research interline flight benefits. The fare calculator is used as a stand-alone research tool (with or without employment verification) or in conjunction with the common information platform 11 where airline employee affiliates may request e-tickets, make space-available listings, and make last minute itinerary changes. The common information platform 11 maintains all information utilizing the latest IATA and The Official Airline Guide (OAG) resources so that all information communicated to the airline employee affiliate is accurate and up-to-date. Such information includes schedule updates, embargoes, fare and agreement changes, and taxes, fees, and charges. Furthermore, during the search result stage 24 the interline fare calculator is customizable and can return the search results based on: departure, arrival, date, flight type registry, flight combinations, flight stops, airline contracts, and miles (distances). Other features of the interline fare calculator include the capability to verify taxes, save search data, calculate taxes, fees, and charges for each leg of a round-trip ticket, verify eligible flights, mark non-eligible flights, and return search results.

Once the airline employee affiliate settles on the desired travel route and expense, the airline employee affiliate may store the itinerary in electronic form in the common information platform 11 as administered by the third party purchase facilitator. The airline employee affiliate may store multiple alternate itineraries within the common information platform 11 if, for example, the airline employee affiliate is unsure whether that original itinerary is conducive to traveling. The common information platform 11 contains all flight information, airline employee affiliate profiles 26 (FIGS. 6-8), and relevant information required for interline travel.

The common information platform 11 can also store custom accounts in the profiles 26 concerning individual airline employee affiliates. Here, the airline employee affiliate has access to future flights, flight history, payment method information, ticket requests, and ticket cancellations or refunds. Any communication with a remote directory that stores airline employee affiliate information is through the LDAP or XML protocol with SSL encrypting, as previously discussed. Furthermore, the profiles 26 stored in the common information platform 11 may include information concerning flight status, dependent status, eligibility, or inactive or suspended employment of eligibility benefits. The common information platform 11 may also store statistical information with regard to certain profiles 26 including search history, itinerary requests, past requests, aggregate tickets requested during a searchable time frame, number of segments flown during a specified time frame, most requested airline, or most requested destination. Additionally, transporting airline administrators may search these statistical categories based on individual employees, groups of employees, or all airline employee affiliates with access to interline travel benefits.

As generally shown in FIG. 9, the airline employee affiliate is then presented with a purchase page 27 where a ticket 28 is purchased. Accordingly, a confirmation page 29 summarizes all relevant travel itinerary information including costs.

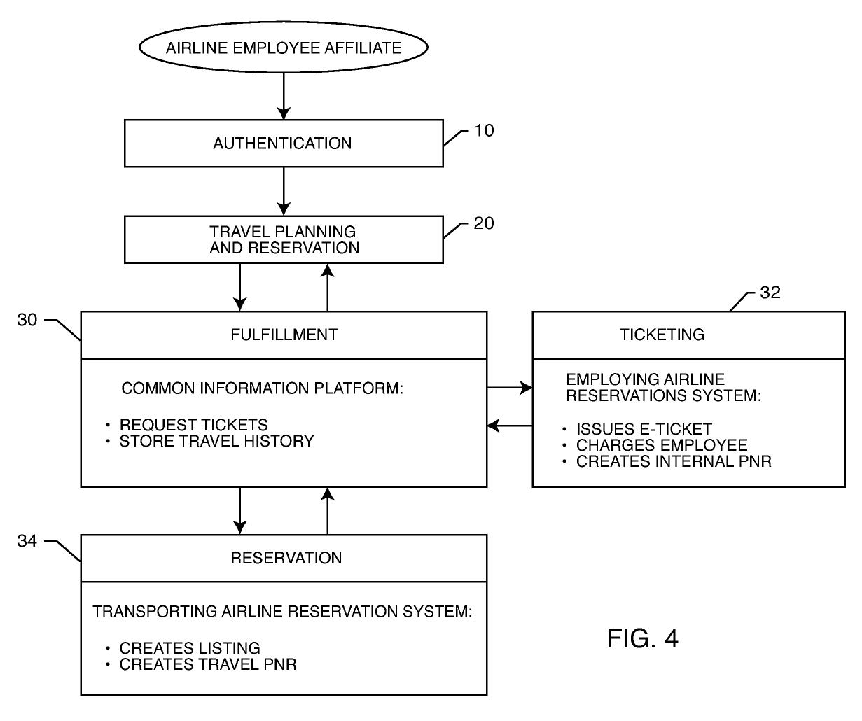

Specifically, fulfillment stage 30 follows the travel planning and reservation stage 20 once the airline employee affiliate chooses an interline travel itinerary. The fulfillment stage 30 includes a variety of ticketing options including traditional self-ticketing, contracted ticketing, and ticketing by the transporting airline. For traditional self-ticketing, as illustrated in FIG. 4, the fulfillment stage 30 includes having the third party purchase facilitator communicate the travel itinerary selected by the airline employee affiliate to the employing airline reservation system. During a ticketing stage 32, under traditional ticketing, the employing airline issues an e-ticket, creates an internal Personal Name Record (PNR/record locator), and collects the funds directly from the airline employee affiliate. The e-ticket data is then transmitted electronically from the employing airline reservation system back to the common information platform 11. The common information platform 11 associates the e-ticket with the travel itinerary of the airline employee affiliate. The e-ticket and travel itinerary is then communicated in electronic form to the transporting airline reservation system for a reservation stage 34. An e-mail ticket request 35, shown in FIG. 6, is only one way to electronically communicate the e-ticket and travel itinerary. The transporting airline thereafter creates the listing and travel r/record locator. The transporting airline transmits the listing and PNR/record locator information back to the common information platform 11 for association and storage with the e-ticket and travel itinerary. The airline employee affiliate is now listed for standby travel with the transporting airline. Since all the information generated by the employing airline and the transporting airline is stored on the common information platform 11, the airline employee affiliate has easy access to any information regarding the interline travel itinerary.

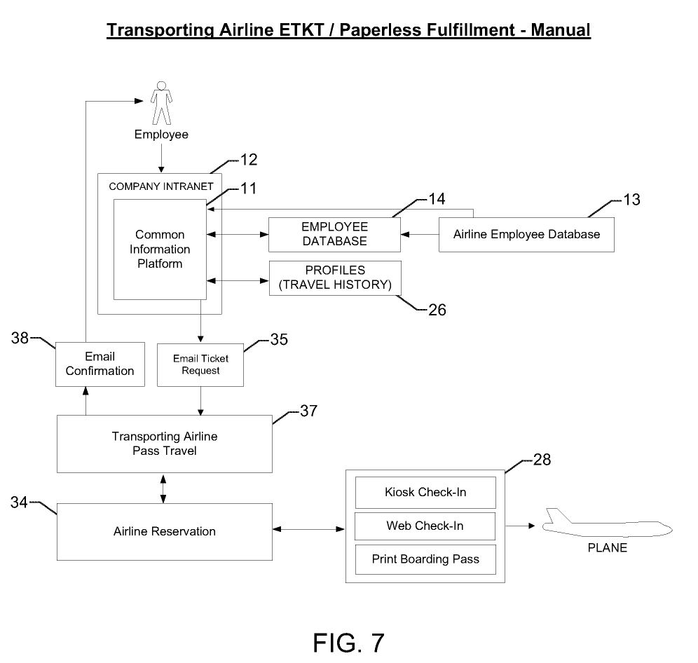

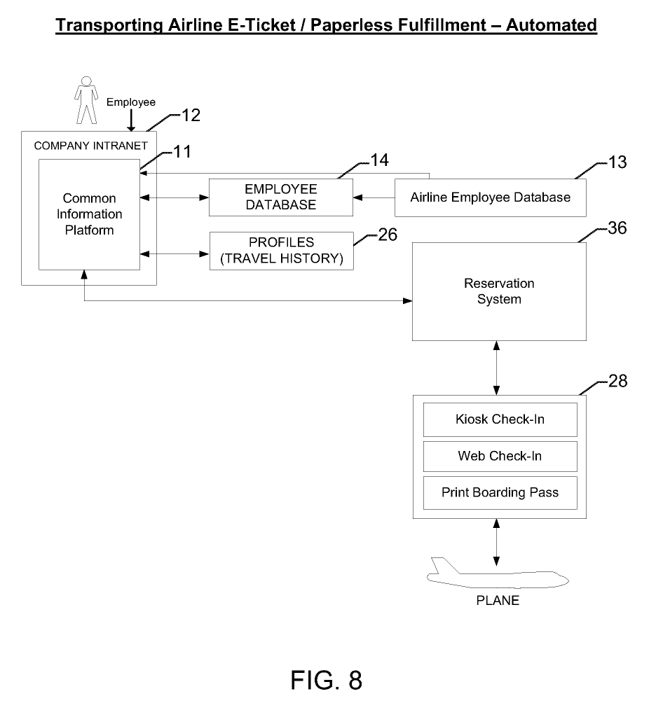

The common information platform 11 is a Universal Electronic Ticketing Platform (UETP). An airline employee affiliate need only make one connection with the common information platform 11 to interline with any participating transporting airline, including the employing airline. The common information platform 11 is able to “translate” any electronic information in and among participating transportation airline reservation systems, HR databases, etc. Special protocols within the common information platform 11 enables intercommunication among all participating transportation airlines. The common information platform 11 is designed to “push” and “pull” information among airline reservation systems in formats automatically compatible with said systems. This inter-connectivity allows airline employee affiliates to take advantage of a set of transporting airline travel tools 28 (FIGS. 7-8), such as online check-in, web check-in, and print boarding pass, because the common information platform 11 is directly connected to each transporting airline reservation system. The UETP is advantageous over the current system because each individual transporting airline does not need to make a direct interline connection with every individual transporting airline. This is particularly useful in that the transporting airline and/or employing airline does not need to create a new reservation system or create a protocol to translate information for automatic reception by either reservation system. In most cases, the transporting airline or employing airline would need to modify a protocol or the reservation system itself to communicate with one another. The common information platform 11 addresses all of these initial communication problems and any changes within the reservation systems of the transporting airline, or employing airline to keep the system up-to-date and interconnected.

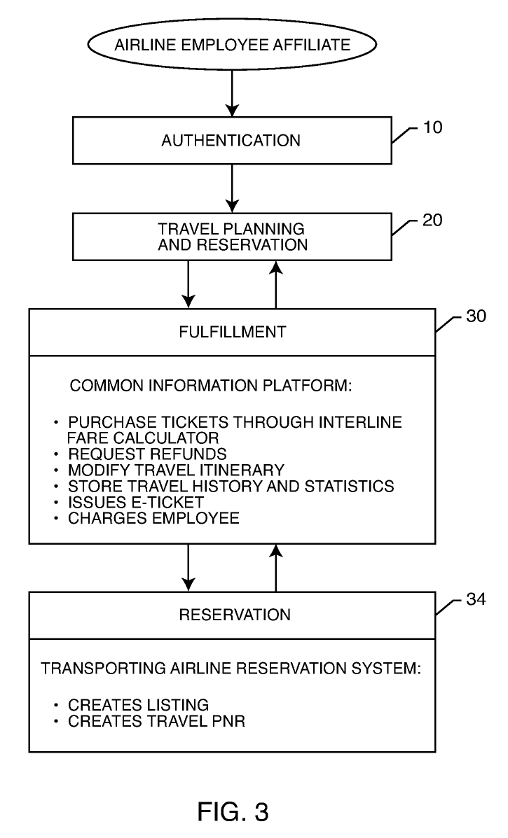

In an alternative embodiment of the present invention, the fulfillment stage 30 is accomplished through contracted ticketing with the third party purchase facilitator as illustrated in FIG. 3. Under contracted ticketing, the third party purchase facilitator is authorized to issue an e-ticket on behalf of the transporting airline via the common information platform 11. The third party purchase facilitator also charges the airline employee affiliate directly. Essentially, the third party purchase facilitator operating the common information platform 11 acts as the validating airline. An interline fare calculator web service 33 manages complete “control” of the e-ticket. In terms of changing itineraries or requesting refunds, the employing airline and transporting airline are not involved. The third party purchase facilitator eliminates any steps requiring the transporting airline or the employing airline to deal directly with the airline employee affiliate. Eliminating these steps saves the transporting airline and the employing airline the costs associated with processing and refunding tickets. Via the common information platform 11, the airline employee affiliate can also cancel, reroute, or modify the interline travel itinerary, or even change transporting airlines online. The airline employee affiliate must pay for any additional fees as required under the terms of the bilateral agreement between the employing airline and the transporting airline. Refunds or credits for less expensive interline travel is returned directly to the airline employee affiliate.

Modification of the interline travel itinerary by the airline employee affiliate is accomplished in a number of different ways including a web-based program, cell phone, PDA, or other electronic communications device. This is particularly useful as the airline employee affiliate is able to quickly switch to an alternative itinerary in case the airline employee affiliate must cancel the original itinerary, for whatever reason. Once the airline employee affiliate changes the interline travel itinerary, a new PNR/record locator is created by the new transporting airline for use with the alternative itinerary. The common information platform 11 then cancels the original itinerary with the original transporting airline and processes the alternate itinerary with the alternative transporting airline. For example, the common information platform 11 sends e-ticket information to the original transporting airline. When the airline employee affiliate decides to change the original itinerary, the common information platform 11 “pulls” control of the e-ticket from the original transporting airline and “pushes” a new e-ticket, corresponding to the transporting airline and transmits back a new PNR/record locator to the common information platform for use with the alternative itinerary, to the second transporting airline. The common information platform 11 automatically streamlines the process of canceling the e-ticket with the first transporting airline and listing the airline employee affiliate with the second transporting airline. All of these changes are done automatically and electronically through the common information platform 11 and corresponding protocols that enable intercommunication among the multiple transporting airline reservation systems.

Furthermore, under contracted ticketing the third party purchase facilitator is authorized to issue an e-ticket on the “stock” (i.e., the billing code used by a transporting airline to issue a paper ticket) of the transporting airline. The stock issued by the third party facilitator can use the billing code of a transporting airline or establish an internal billing code unique to the third party purchase facilitator. The third party purchase facilitator can then use either the billing code of the transporting airline or the unique internal billing code to settle purchases through a clearing house. The detailed billing process is disclosed in further detail later in the specification. The third party purchase facilitator may issue a paper ticket or an electronic authorization if the transporting airline does not offer e-ticketing.

While the airline employee affiliate is in communication with the common information platform 11 during contracted ticketing, the common information platform 11 is also in communication with the reservation system of the transporting airline. During a reservation stage 34, electronic travel itinerary data, including the e-ticket, is communicated to the transporting airline in a format automatically compatible with the transporting airline reservation system. The transporting airline uses the electronic travel itinerary data to create a listing and a PNR/record locator for the airline employee affiliate. The listing information and PNR/record locator is then communicated back to the common information platform 11 in electronic form. The common information platform 11 receives the listing and PNR/record locator information from the transporting airline and associates this information with the electronic travel itinerary and e-ticket information. The information is stored in the common information platform 11 wherein the airline employee affiliate may access the reservation information from any one of the access points as previously discussed. The airline employee affiliate may view, change, or cancel the itinerary at any time via the common information platform 11. The common information platform 11 automatically communicates any changes to the travel itinerary to the transporting airline.

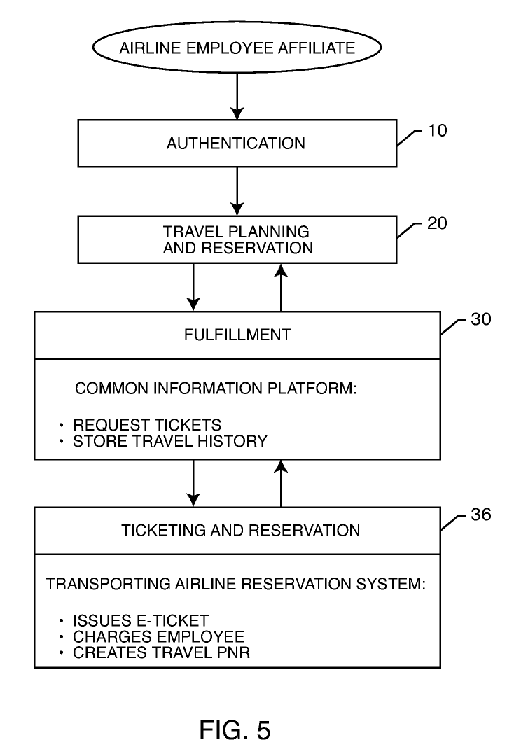

In yet another alternative approach to the fulfillment stage 30, ticketing is conducted directly by the transporting airline. As shown in the flowcharts of FIGS. 5, 7 and 8, the airline employee affiliate can search flights, calculate fares, and create a travel itinerary, as previously discussed, in the travel planning and reservation stage 20. During the fulfillment stage 30, under ticketing by the transporting airline, the common information platform 11 translates the relevant travel itinerary information in electronic form to the transporting airline reservation system. The electronic itinerary information is sent in a format compatible with the transporting airline reservation system. For manual paperless e-ticketing, the e-mail ticket request 35 will suffice to convey the ticket request in a format compatible with the transporting airline reservation system. Although, any other form of electronic communication known in the art will also suffice.

After receiving the itinerary information in electronic form, the transporting airline reservation system issues an e-ticket, paper ticket, paperless ticket, ticketless travel, or other authorization or ticketing, charges the airline employee affiliate directly, and creates a listing and PNR/record locator for the airline passenger during a ticketing and reservation stage 36. The travel information created by the transporting airline is then communicated back to the common information platform 11 for association and storage with the travel itinerary information. Again, the airline employee affiliate has around-the-clock access to all itinerary and travel information via the common information platform 11, through any of the access points as previously discussed. For manual paperless e-ticketing in FIG. 7, a transporting airline passenger travel database 37 sends an e-mail confirmation 38 to the airline employee affiliate while in communication with the transporting airline reservation system during the reservation stage 34.

Information stored by the common information platform 11 is dynamic. This means that the common information platform 11 automatically communicates relevant travel itinerary information among and between employing airlines and transporting airlines. The common information platform 11 sorts, formats, and transmits electronic data in a format automatically compatible with any reservation system via a set of conversion protocols specific to the reservation system of each airline carrier. These protocols within the common information platform 11 provide greater flexibility and enforcement of the fare restriction rules set forth in each bilateral agreement. Additionally, the common information platform 11 sends only relevant information required by either the transporting airline or the employing airline to successfully administer interline travel. Hence, the information stored by the common information platform 11 is dynamic—i.e., the information and format changes with each individual airline carrier.

To this point, the reservation and ticketing process for space-available or positive-space seats for airline employee affiliates is facilitated by first validating the employment status of an airline employee affiliate desiring to travel interline. Answers to a series of questions as inputted by the airline employee affiliate are compared with data stored in a HR database of the employing airline affiliate Once validated, the airline employee affiliate is granted access to an interline fare calculator, such as the ZED Fare Calculator™, which is associated with the common information platform 11 reservation and ticketing system. Through the common information platform 11, the airline employee affiliate can search flights, calculate fares, request tickets, store current travel itineraries, and examine past travel itineraries. Once the airline employee affiliate chooses an itinerary and moves to the fulfillment stage 30, the common information platform 11 processes the travel itinerary request under any one of three ticketing solutions: (1) traditional self ticketing by the employing airline; (2) contracted ticketing by the third party purchase facilitator; or (3) ticketing by the transporting airline.

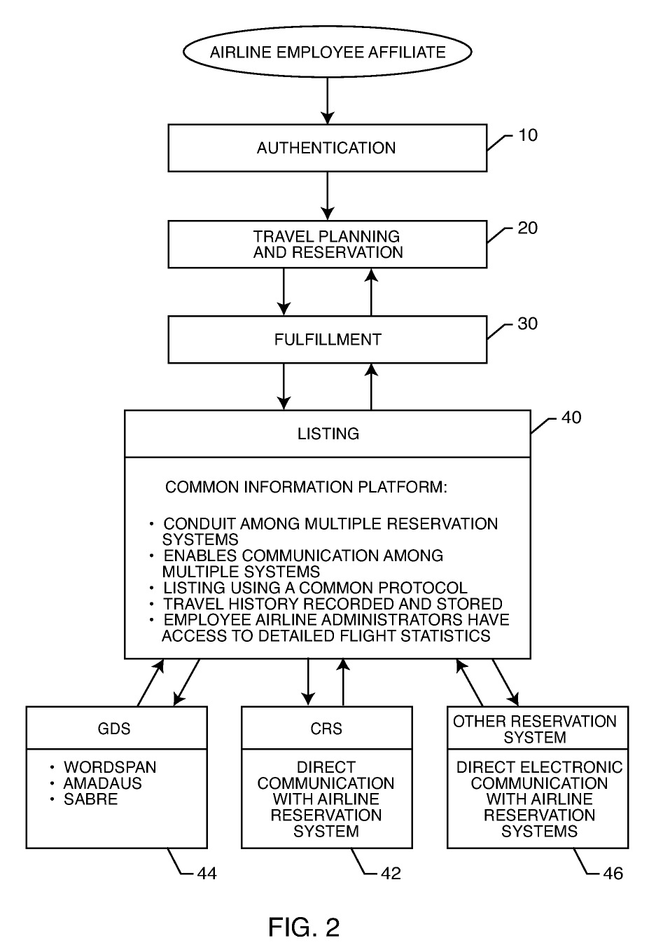

The next step in the travel reservation and ticketing process of the present invention is a listing stage 40, which is illustrated in the flowchart of FIG. 2. FIG. 2 briefly illustrates the stages of reserving space-available seats to airline employee affiliates leading up to the listing stage 40. The airline employee affiliate is verified during the authentication stage 10, selects an interline travel itinerary during the travel planning and reservation stage 20, and receives relevant e-ticket information during any of the three types of fulfillment stages 30. The common information platform 11 automatically makes the interline travel reservation through any one of a number of service provider systems during the listing stage 40. The information communicated to the service provider systems is dynamically formatted for automatic reception. The PNR/record locator is the basic form of computerized airline travel record. A few airlines host independent reservation systems or have direct access to a Central Reservation System (CRS) 42 within a virtual “partition” in a Global Distribution System (GDS) 44. The GDS's are administered by several service providers including WORLDSPAN, AMADAUS, and SABRE. The common information platform 11 enables communication among the multiple service providers, including the GDS's, CRS's, and any other electronic reservation systems 46. It is also conceived in the present invention that the common information platform 11 could incorporate a global common protocol that requires participating airline reservation systems to be re-designed for compatibility. Although, this system is less efficient than having the common information platform 11 translate relevant travel itinerary and electronic data information among participating airlines because the onerous of compatibility is placed back on the participating airlines. The airline employee affiliate uses the interline fare calculator to communicate with the various service provider systems via the common information platform 11. All required form fields are easily repopulated by the common information platform 11 since the desired travel itinerary and all relevant travel information, including e-ticket and PNR/record locator information, are stored therein. Thus, the listing process does not involve multiple steps for the airline employee affiliate. The airline employee affiliate can cancel or modify any listings online, with the option to view all future travel plans and recent travel history. A common information platform confirmation e-mail 48 (FIG. 9) is always sent to the employee affiliate concerning any changes to the travel itinerary.

In an alternative embodiment, the common information platform 11 communicates directly with the transporting airline website or CRS 42 and completely bypasses the GDS 44. Control of the e-ticket is directly “pushed” (i.e., electronically communicated) to the transporting airline. The transporting airline Departure Control System (DCS), reservation system, or other internal system then retains “control” of the e-ticket through the various stages of travel. The stages of travel communicated back to the common information platform 11 start with the issuance of an e-ticket by the transporting airline.

In the embodiment of FIG. 6, where the employing airline is the transporting airline, a transporting airline staff travel office 50 notifies the airline employee affiliate of the interline travel itinerary and e-ticket via an electronic message (e.g., an e-mail 52) or by a postal service delivery 54. After the airline employee affiliate receives the e-ticket from the transporting airline, the e-ticket is considered open (“O”). The following indicator flight stages include airport assignment (“A”), airport check-in (“C”), boarding (“B”), and lastly the flown status (“F”). If the plane departs and the status of the airline employee affiliate e-ticket does not indicate “flown”, then the e-ticket status indicator moves back to the “open” stage. The DSC, reservation system, or other internal system communicates e-ticket status in electronic form directly to the common information platform 11 during these flight stages. All airline employee affiliate travel history is recorded within the common information platform 11. Employing and transporting airline administrators with access to the common information platform 11 thus have complete control over the detailed airline employee affiliate interline travel statistics. The final indicator of “flown” is the last correspondence between the transporting airline and the common information platform 11 with regard to any individual travel itinerary.

Consider that an airline employee affiliate decides not to fly or misses the flight. The “flown” indicator would not be communicated back to the common information platform 11 of the third party purchase facilitator. The airline employee affiliate could log into the common information platform 11 and request an e-ticket on another flight. The new flight itinerary could use the same transporting airline or a different transporting airline, such as the employing airline The airline employee affiliate pays for additional fees, taxes, or charges, if any, online and is issued a new e-ticket number and new PNR/record locator for the new itinerary. Control of the e-ticket is pushed to the new transporting airline, or back to the original transporting airline, depending on the new travel itinerary requested by the airline employee affiliate.

For example, an airline employee affiliate purchases an e-ticket for travel from Los Angeles International Airport (LAX) to London Heathrow Airport (LHR) on British Airways. But, the airline employee affiliate is unable to fly because the flight is full, the airline employee affiliate misses the flight, etc. The airline employee affiliate can change the travel itinerary by logging back into the common information platform 11 of the third party purchase facilitator. Say the airline employee affiliate locates the LAX-LHR flight on Virgin Atlantic Airways during the search for a new interline travel itinerary. The common information platform 11 cancels the travel reservation with the original transporting airline, British Airways, and applies credit from the original itinerary to the new itinerary. A new PNR/record locator is created and control of the e-ticket is now with the new transporting airline: Virgin Atlantic. Virgin Atlantic then retains control of the e-ticket through the various stages of travel. The final e-ticket status communicated from Virgin Atlantic to the common information platform 11 is “flown”.

Billing is initiated once interline travel is complete. The billing procedure depends on whether the airline employee affiliate purchased the interline ticket itinerary via (1) traditional self-ticketing by the employing airline; (2) contracted ticketing by the third party purchase facilitator; or (3) ticketing by the transporting airline. In the case of traditional self-ticketing by the employing airline, the airline employee affiliate is billed directly by the employing airline. Cost settlements are then settled between the employing airline and the transporting airline on a periodic basis via a clearing house. Similarly, under ticketing by the transporting airline, the airline employee affiliate is billed directly by the transporting airline. In both the scenarios above, ticket refunds and billing disputes are handled by each individual airline. Hence, the airline employee affiliate must learn the rules and regulations concerning interline airline travel for each individual transporting airline.

Under contracted ticketing through the third party purchase facilitator, the airline employee affiliate has a number of payment and billing options as illustrated in the FIG. 9 flowchart. In one embodiment, the airline employee affiliate banking institution 56 is debited directly by the common information platform 11. In another embodiment, the airline employee affiliate pays for the e-ticket, paper ticket, paperless ticket, ticketless travel, or other travel authorization or ticketing through a passenger banking system 58 such as a credit card or company supported Universal Air Travel Plan (UATP) employee program. UATP is a worldwide corporate travel payment network owned and issued by participating airlines. Each airline employee affiliate would be issued a UATP account number wherein in no card is actually issued or needed. The UATP accounts work similar to credit cards, except that the employing airline would be financially responsible for interline travel expenses incurred by employees. The passenger banking system 58 of each individual airline employee affiliate is associated with a stored e-ticket information 60. Once the status “flown” is returned to the common information platform 11, a common information platform banking system 62 collects the funds for distribution. The common information platform banking system 62 then settles the outstanding bill with either an employing airline banking system 64 or a clearing house 66. Each week UATP bills the employing airline banking system 64, which uses the assigned accounting code for payroll deduction or charges the airline employee affiliate directly via a personal credit card. The airline charging the personal credit card incurs any associated merchant fees. Additionally, the common information platform 11 can utilize the billing code from the transporting airline as a city ticket office (CTO). Billing as a CTO enables the common information platform 11 to handle all billing issues concerning interline travel directly with the transporting airline.

Alternatively, the third party purchase facilitator could use a unique billing code and settle all billing issues through the clearing house 66, or the Billing and Settlement Plan (BSP) set up by the International Air Transport Association (IATA). Here the third party purchase facilitator is acting as another airline.

The web-based common information platform 11 provides an airline employee affiliate with round-the-clock online access to account history, including previous travel itineraries and future travel itineraries. The airline employee affiliate may also directly request travel refunds or travel itinerary changes through the common information platform 11. Since the common information platform 11 has complete control over the reservation and ticketing process, the third party purchase facilitator is able to automatically “push” and “pull” e-tickets between transporting airlines. The common information platform 11 provides maximum flexibility and more “green path” travel reservation opportunities. Additionally, the airlines do not need to buy or develop a reservation and/or ticketing system to be compatible with other airline reservation systems. Thus, there are no development costs for the transporting airlines. The common information platform 11 also reduces settlement disputes between transporting airlines and employing airlines because the third party purchase facilitator automatically and electronically facilitates the terms of the agreements between the participating airlines.

From the standpoint of the employing airline, the common information platform 11 provides complete administrative control over the reservation and ticketing process. The common information platform 11 stores detailed statistics including how employees travel and the most requested transporting airlines. The common information platform 11 provides a stand-alone, maintenance-free interline travel ticketing solution. Hence, employing airlines avoid administrative and financial costs for administering such a system.

Conventionally, most airlines have intranet-based online forms where employees create interline travel itineraries. The intranets are not usually fully and automatically compatible, if in communication at all. The process embodying the present invention acts to integrate the separate intranets and corresponding reservation systems by completing and formatting these online forms through a series of conversion protocols. The web-based common information platform 11 used by the third party purchase facilitator “translates” the individual airline form-based information for storage in a format that is compatible with all participating airlines. Airlines can therefore use already developed reservation system technology. Further, the information is dynamic, so the common information platform 11 can deliver the same information in a different format (e.g., date). Hence, the common information platform 11 provides universal compatibility among all participating airlines.

Additionally, the present invention has numerous administrative benefits. Airlines can request bilateral interline travel agreements online. For instance, employing airlines can negotiate with each participating airline individually, or the employing airline can negotiate with all participating airlines at once. Airlines can automatically download approved contracts with no need to modify the agreements once approved. Or, the bilateral agreements can be edited and approved online using electronic signatures and comment boxes. Additionally, the common information platform 11 can incorporate all bilateral agreements in airline employee affiliate searches (i.e., ZED, ID95, ID90, ID80, ID75, ID50, flat rates, SVC, reduced rate, or free of charge, and the like), including travel privileges offered by the employing airline.

Bilateral agreements can also be negotiated on an employee by employee basis. For example, Virgin Airlines can request a contract for an airline employee affiliate to travel on Alaska Airlines. Through the common information platform 11, Virgin Airlines can submit a proposed bilateral agreement that allows the airline employee affiliate to travel on Alaska Airlines. Alaska Airlines can accept the proposed contract or respond to the proposed contract with a counter offer. Alternatively, Alaska Airlines may decline the proposed contract altogether. The process of contract offer, counter offers, and declining contracts is part of the negotiation process.

If Alaska Airlines accepts the proposed contract from Virgin Airlines, Virgin Airlines receives an electronic communication via the common information platform 11 indicating that Alaska Airlines approved the requested contract. The approved contract is automatically uploaded to the common information platform 11. The contract is only enforceable during the term specified in the agreement. The contract automatically expires in the event that the airlines to the bilateral agreement state an expiration date.

If Alaska Airlines responds to Virgin Airlines proposed contract with a counter offer, Virgin Airlines receives an electronic message via the common information platform 11 indicating such a response. Virgin Airlines may then directly link into the common information platform 11 to view the counter offer by Alaska Airlines. The common information platform 11 displays the original contract offer from Virgin Airlines beside the new counter offer contract from Alaska Airlines, including any notes. Virgin Airlines may accept the counter offer, make another counter offer, or decline the proposed contract altogether. Airlines can condition acceptance of the bilateral agreement only if reciprocity is granted. In this case both agreements (the original agreement and reciprocal agreement) are loaded into the common information platform 11 at the time of acceptance.

If Alaska Airlines chooses to decline the original contract offer from Virgin Airlines, Virgin Airlines receives an electronic message stating so. The electronic message may also include comments from Alaska Airlines.

As an added administrative control benefit to the airlines, the common information platform 11 stores bilateral contracts in several different categories. These categories include contracts awaiting approval, declined contracts, contracts requiring feedback, active contracts, and contracts set to expire within 60 days. For contracts awaiting approval, airlines may resubmit the contract to the receiving airline. The common information platform 11 also stores information on a complete history of all contracts, including declined contracts and any information pertaining thereto. Contracts requiring feedback include contract offers and counter offer contracts from other airlines. Active contracts are sortable by alphabetical order, contract date, expiration date, date range, or other searchable field known in the art. Furthermore, contracts that expire in 60 days are highlighted.

Transporting airlines can also input embargo and flight restriction notices by flight number, range, or markets specific to each airline. Notification is automatically sent to all affected airlines and airline employee affiliates listed on the embargoed or restricted flights. Notification can occur by e-mail, text message, voice mail, or other electronic communication device associated with the airline employee affiliate. Listing embargos or restricted flights is airline specific. Expired embargoes and flight restrictions are automatically deleted from the common information platform system.

The common information platform 11 is available twenty-four hours a day, seven days a week via a secure web-based protocol that is conveniently accessible from home, work, or while on the road. The common information platform 11 compiles and stores extensive airline employee affiliate statistics. Employing airlines can use this statistical data for cost-saving analysis (e.g., busiest day/hour and fare searching vs. email requests). Furthermore, the common information platform 11 includes an airline member contact directory, Federal Express delivery options (for an additional fee), and secure transfer of credit card information for e-mail ticket requests. The user-interface of the common information platform 11 includes age drop down boxes for dependents for fast age verification and allows for the addition or exclusion of subsidiaries, affiliates, or franchisees as alliance partners.

The web-based common information platform 11 also has a variety of employee benefits and support. For example, airline employee affiliates have access to multi-media instructional tutorials and live customer service via the phone or web-based application. The common information platform 111 includes a full schedule of airline flights continually updated by Official Airline Guide Inc. (OAG), a global content management company specializing in travel and transportation. OAG compiles flight details for over 1,000 airlines and more than 3,000 airports and travel service providers. The airline schedules provided by OAG are updated regularly. Embargo/flight restriction notices and airline pass policy information are also accessible to airline employee affiliates as previously discussed. Airline employee affiliates can make one-click travel reservation requests via a secure web-based protocol or intranet accessible, twenty-four hours a day, seven days a week. Fare searches include, but are not limited to, one-way, round trip, and multi-city travel (including flights with stops enroute), multiple carriers, (e.g., starting travel from LAX to LHR on United Airlines, continuing travel on British Airways from LHR to Hong Kong (HKG)), regional non-code-share flights (e.g., United Express flights operated by SkyWest), multiple languages, multiple fare restrictions (ZED, ID95, ID90, ID80, ID75, ID50, flat rate SVC, reduced rate, or free of charge, and other agreements of the like), and employing airline flight schedules. Airline employee affiliates may select multiple passengers and obtain an itinerary overview having fare subtotal (including taxes and all assorted fees).

The common information platform 11 can also create and store airline employee affiliate profiles. Profile data contains the following: name, date of birth, security questions, addresses, billing address, mailing address, dependents, telephone numbers, default airports, e-mail address, credit card information, and SMS text advice check box. The airline employee affiliate profile is also stored in association with flight information. Airline employee affiliate profiles can be validated by any of the methods discussed above.

Although several embodiments have been described in some detail for purposes of illustration, various modifications may be made without departing from the scope and spirit of the invention. Accordingly, the invention is not to be limited, except as by the appended claims.

What is claimed is:

1. A process for reserving and ticketing space-available and positive-space available seats to an airline employee affiliate, the steps comprising:
developing an interline travel itinerary for the airline employee affiliate for travel on a transporting airline;
processing the interline travel itinerary in electronic form in a common information platform administered by a third party purchase facilitator;
associating an electronic ticket data with the interline travel itinerary in the common information platform, wherein the common information platform formats the electronic ticket data and the interline travel itinerary for automatic reception by a transporting airline reservation system; and
transmitting the interline travel itinerary to the transporting airline reservation system for listing the airline employee affiliate for travel on the transporting airline.

2. The process of claim 1, including the step of verifying eligibility of the airline employee affiliate by retrieving employment information from an employer database, wherein the verifying step regulates the access of the airline employee affiliate to the common information platform.

3. The process of claim 1, wherein the developing step includes the step of providing electronic access to the common information platform through a web-based program, an intranet, and a kiosk.

4. The process of claim 1, wherein the developing step includes the step of searching fares of at least the transporting airline using an interline fare calculator accessible through the common information platform.

5. The process of claim 1, wherein the developing step includes the step of calculating a travel expense through the common information platform including, fares, taxes, fees, and services charges applicable to non-revenue interline travel.

6. The process of claim 1, wherein the processing step includes the step of generating the electronic ticket data within the common information platform based on the interline travel itinerary developed by the airline employee affiliate.

7. The process of claim 1, including the step of accepting the electronic ticket data in the common information platform from the transporting airline reservation system, whereby the transporting airline reservation system produces the electronic ticket data based on the interline travel itinerary transmitted to the transporting airline reservation system by the common information platform.

8. The process of claim 1, wherein the processing step includes the steps of:
formatting the interline travel itinerary in the common information platform for compatibility with an employing airline reservation system;
transferring the interline travel itinerary in electronic form for automatic reception by the employing airline reservation system, wherein the employing airline reservation system creates the electronic ticket data based on the interline travel itinerary transferred by the common information platform; and
receiving the electronic ticket data in the common information platform from the employing airline reservation system.

9. The process of claim 1, including the step of modifying the interline travel itinerary by canceling the electronic ticket data with the transporting airline reservation system through the common information platform.

10. The process of claim 1, including the step of storing itineraries, travel history, and airline employee travel statistics in an airline employee affiliate profile within the common information platform, wherein the stored information is accessible by the airline employee affiliate or an employing airline.

11. The process of claim 1, including the step of notifying the airline employee affiliate of an embargo or flight restriction via an electronic message, wherein the notification originates from the common information platform.

12. The process of claim 1, including the step of listing the airline employee affiliate for standby flight on the transporting airline, wherein the boarding priority of the airline employee affiliate is based off employment information accessible by the common information platform.

13. The process of claim 1, including the step of adding or subtracting a dependent, subsidiary, or affiliate from the interline travel itinerary through the common information platform, wherein the common information platform automatically updates the travel itinerary and electronic ticket data transmitted to the transporting airline reservation system.

14. The process of claim 1, including the step of facilitating the negotiation of a bilateral interline travel agreement, wherein the employing airline electronically conveys a contract offer to the transporting airline through the common information platform.

15. A process for reserving and ticketing space-available and positive-space available seats to an airline employee affiliate, the steps comprising:
verifying eligibility of the airline employee affiliate by retrieving employment information from an employer database, wherein verification determines the access of the airline employee affiliate to a common information platform administered by a third party purchase facilitator;
developing an interline travel itinerary for the airline employee affiliate for travel on a transporting airline;
formatting the interline travel itinerary in the common information platform for compatibility with an employing airline reservation system;
transferring the interline travel itinerary in electronic form for automatic reception by the employing airline reservation system, wherein the employing airline reservation system creates an electronic ticket data based on the interline travel itinerary transferred by the common information platform;
receiving the electronic ticket data in the common information platform from the employing airline reservation system;
associating the electronic ticket data with the interline travel itinerary in the common information platform, wherein the common information platform formats the electronic ticket data and the interline travel itinerary for automatic reception by a transporting airline reservation system; and
transmitting the interline travel itinerary to the transporting airline reservation system for listing the airline employee affiliate for travel on the transporting airline.

16. The process of claim 15, wherein the developing step includes the step of providing electronic access to the common information platform through a web-based program, an intranet, and a kiosk.

17. The process of claim 15, wherein the developing step includes the step of searching fares of at least the transporting airline using an interline fare calculator accessible through the common information platform.

18. The process of claim 15, wherein the developing step includes the step of calculating a travel expense through the common information platform including, fares, taxes, fees, and services charges applicable to non-revenue interline travel.

19. The process of claim 15, including the step of modifying the interline travel itinerary by canceling the electronic ticket data with the transporting airline reservation system through the common information platform.

20. The process of claim 15, including the step of storing itineraries, travel history, and airline employee travel statistics in an airline employee affiliate profile within the common information platform, wherein the stored information is accessible by the airline employee affiliate or an employing airline.

21. The process of claim 15, including the step of notifying the airline employee affiliate of an embargo or flight restriction via an electronic message, wherein the notification originates from the common information platform.

22. The process of claim 15, including the step of listing the airline employee affiliate for standby flight on the transporting airline, wherein the boarding priority of the airline employee affiliate is based off employment information accessible by the common information platform.

23. The process of claim 15, including the step of adding or subtracting a dependent, subsidiary, or affiliate from the interline travel itinerary through the common information platform, wherein the common information platform automatically updates the travel itinerary and electronic ticket data transmitted to the transporting airline reservation system.

24. The process of claim 15, including the step of facilitating the negotiation of bilateral interline travel agreement, wherein the employing airline electronically conveys a contract offer to the transporting airline through the common information platform.
